(19) United States
(12) Patent Application Publication
(10) Pub. No.: US 2018/0157908 A1
(43) Pub. Date: Jun. 7, 2018

(54) GAZE-TRACKING SYSTEM AND METHOD OF TRACKING USER'S GAZE

(71) Applicant: Varjo Technologies Oy, Helsinki (FI)

(72) Inventors: Oiva Arvo Oskari Sahlsten, Salo (FI); Klaus Melakari, Oulu (FI); Mikko Ollila, Tampere (FI); Ville Miettinen, Helsinki (FI)

(21) Appl. No.: 15/648,886

(22) Filed: Jul. 13, 2017

Related U.S. Application Data
(63) Continuation-in-part of application No. 15/366,424, filed on Dec. 1, 2016, now Pat. No. 9,711,072.

(51) Int. Cl. G06K 9/00; G06T 7/73; G06K 9/20; G02B 27/01

(52) U.S. Cl. CPC G06K 9/00604; G06T 7/73; G06T 2207/30201; G02B 27/0172; G06T 2207/10048; G06K 9/2027

(57) ABSTRACT

A gaze-tracking system for use in a head-mounted display apparatus includes means for producing structured light including a plurality of illuminators for emitting light pulses. Furthermore, the gaze-tracking system includes at least one camera for capturing an image of reflections of the structured light from the user's eye, wherein the image is representative of a form of the reflections and a position of the reflections on an image plane of the at least one camera. Moreover, the gaze-tracking system includes a processor configured to control the means for producing the structured light to illuminate the user's eye with the structured light and to control the at least one camera to capture the image of the reflections of the structured light, and to process the captured image to detect a gaze direction of the user.

### CROSS-REFERENCE TO RELATED APPLICATIONS

This application claims the benefit of and is a continuation-in-part application of U.S. patent application Ser. No. 15/366424, titled “DISPLAY APPARATUS AND METHOD OF DISPLAYING USING FOCUS AND CONTEXT DISPLAYS” and filed on Dec. 1, 2016, the disclosure of which is incorporated herein by reference in its entirety.

### TECHNICAL FIELD

The present disclosure relates generally to display apparatuses; and more specifically, to gaze-tracking systems for use in head-mounted display apparatuses. Furthermore, the present disclosure also relates to methods of tracking a user's gaze via the aforementioned gaze-tracking systems.

### BACKGROUND

In recent times, there has been a rapid increase in use of technologies such as virtual reality, augmented reality, and so forth, for presenting a simulated environment (or a virtual world) to a user. Typically, the user uses a device (for example, such as a virtual reality device, an augmented reality device, and the like) for experiencing such a simulated environment. Furthermore, in use, the user generally wears (namely, supports) the device on their head.

Nowadays, such devices often employ a technique such as gaze-tracking (namely, eye tracking) to determine a gaze direction of the user. Typically, the gaze-tracking is associated with determination of position of pupils of eyes of the user. Generally, an illuminator is employed for emitting light towards the user's eyes. Furthermore, reflection of the emitted light from the user's eyes is used as reference for determining the position of the pupils the user's eyes with respect to the reflections. Typically, a plurality of illuminators is used to produce multiple reflections for such determination of position of the pupils of the user's eyes.

However, there exist a number of drawbacks associated with such use of multiple reflections for determining the position of the pupils of the user's eyes. Firstly, the user may have their eyes partially closed. In such an instance, some of the multiple reflections may be absent (for example, the light may not be reflected by the user's eyelids). Furthermore, such absence of reflections leads to inaccuracies in the determined position of the pupils of the user's eyes. Secondly, in an instance when some of the reflections are obscured by the eyelids of the user, the position of visible reflections may be inaccurately identified. It will be appreciated that such inaccurate identification of reflections leads to further inaccuracies associated with the determined position of the pupils of the user's eyes. Thirdly, ambient light sources may be present near the user that may produce reflections on the eyes thereof. In such an instance, reflections produced by light emitted by the ambient light sources may be inaccurately considered to be reflections of light emitted by the plurality of illuminators. Consequently, the position of the pupils of the user's eyes determined using such reflections of light emitted by the ambient light sources is inaccurate.

Therefore, in light of the foregoing discussion, there exists a need to overcome the aforementioned drawbacks associated with use of multiple reflections of light from a plurality of illuminators for gaze-tracking.

### SUMMARY

The present disclosure seeks to provide a gaze-tracking system for use in a head-mounted display apparatus.

The present disclosure also seeks to provide a method of tracking a user's gaze, via a gaze-tracking system of a head-mounted display apparatus.

The present disclosure seeks to provide a solution to the existing problems associated with use of multiple reflections of light for gaze-tracking of a user. An aim of the present disclosure is to provide a solution that overcomes at least partially the problems encountered in the prior art, and provides a robust and efficient gaze-tracking system that eliminates inaccuracies associated with use of multiple reflections of light in existing gaze-tracking techniques.

In one aspect, an embodiment of the present disclosure provides a gaze-tracking system for use in a head-mounted display apparatus, the gaze-tracking system comprising:
means for producing structured light, wherein the produced structured light is to be used to illuminate a user's eye when the head-mounted display apparatus is worn by the user, the means for producing the structured light comprising a plurality of illuminators for emitting light pulses;
at least one camera for capturing an image of reflections of the structured light from the user's eye, wherein the image is representative of a form of the reflections and a position of the reflections on an image plane of the at least one camera; and
a processor coupled in communication with the means for producing the structured light and the at least one camera, wherein the processor is configured to control the means for producing the structured light to illuminate the user's eye with the structured light and to control the at least one camera to capture the image of the reflections of the structured light, and to process the captured image to detect a gaze direction of the user.

In another aspect, an embodiment of the present disclosure provides a method of tracking a user's gaze, via a gaze-tracking system of a head-mounted display apparatus, the method comprising:
producing structured light, via a plurality of illuminators, to illuminate a user's eye when the head-mounted display apparatus is worn by the user;
capturing an image of reflections of the structured light from the user's eye, the image being representative of a form of the reflections and a position of the reflections on an image plane of the at least one camera; and
processing the captured image to detect a gaze direction of the user.

Embodiments of the present disclosure substantially eliminate or at least partially address the aforementioned problems in the prior art, and enable accurate and efficient tracking of a user's gaze.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a block diagram of a gaze-tracking system for use in a head-mounted display apparatus, in accordance with an embodiment of the present disclosure;

FIGS. 2, 3, 4 and 5 illustrate exemplary implementations of the gaze-tracking system (as shown in FIG. 1) in use within a head-mounted display apparatus, in accordance with various embodiments of the present disclosure;

FIG. 6 is an exemplary image of a user's eye (such as the user's eye of FIG. 2) captured by at least one camera (such as the at least one camera of FIG. 2), in accordance with an embodiment of the present disclosure; and

FIG. 7 illustrates steps of a method of tracking a user's gaze, via a gaze-tracking system of a head-mounted display apparatus, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a gaze-tracking system for use in a head-mounted display apparatus, the gaze-tracking system comprising:
means for producing structured light, wherein the produced structured light is to be used to illuminate a user's eye when the head-mounted display apparatus is worn by the user, the means for producing the structured light comprising a plurality of illuminators for emitting light pulses;
at least one camera for capturing an image of reflections of the structured light from the user's eye, wherein the image is representative of a form of the reflections and a position of the reflections on an image plane of the at least one camera; and
a processor coupled in communication with the means for producing the structured light and the at least one camera, wherein the processor is configured to control the means for producing the structured light to illuminate the user's eye with the structured light and to control the at least one camera to capture the image of the reflections of the structured light, and to process the captured image to detect a gaze direction of the user.

In another aspect, an embodiment of the present disclosure provides a method of tracking a user's gaze, via a gaze-tracking system of a head-mounted display apparatus, the method comprising:
producing structured light, via a plurality of illuminators, to illuminate a user's eye when the head-mounted display apparatus is worn by the user;
capturing an image of reflections of the structured light from the user's eye, the image being representative of a form of the reflections and a position of the reflections on an image plane of the at least one camera; and
processing the captured image to detect a gaze direction of the user.

The aforementioned gaze-tracking system and the method of tracking a user's gaze employ means for producing structured light comprising the plurality of illuminators, to illuminate the user's eye when the head-mounted display apparatus is worn by the user. Such use of structured light enables the gaze-tracking system to determine a shape of the user's eye. Further, the shape of the user's eye can be employed to correct the detected gaze direction of the user. Therefore, errors in the detected gaze direction associated with differences in eye shapes of different users are minimized. Consequently, an accuracy associated with detection of gaze direction of the user is increased by taking into account the shape of the user's eye while detecting the gaze direction thereof. Furthermore, the use of structured light to illuminate the user's eye, using the plurality of illuminators enables to determine the positions of reflections of the structured light based on forms thereof (such as, using the image captured by the at least one camera that is representative of the form of the reflections and the positions of the reflections). Therefore, such use of structured light enables to determine the positions of the reflections of the structured light to high accuracy and consequently, enables accurate detection of the gaze direction of the user. Additionally, such use of structured light enables to substantially overcome errors associated with occlusion of light that is used to illuminate the user's eye, for example, by the user's eyelids. Also, errors associated with presence of reflections from ambient light sources can be substantially minimized. Therefore, the detection of the gaze direction of the user using structured light enables to substantially overcome drawbacks associated with use of multiple reflections of light in existing gaze-tracking techniques.

Throughout the present disclosure, the term “gaze-tracking system” used herein relates to specialized equipment for detecting a direction of gaze (namely, a gaze direction) of the user. The head-mounted display apparatus uses the gaze-tracking system for determining the aforesaid gaze direction via non-invasive techniques. Beneficially, an accurate detection of the gaze direction facilitates the head-mounted display apparatus to closely implement gaze contingency thereon.

Throughout the present disclosure, the term “head-mounted display apparatus” used herein relates to specialized equipment that is configured to present a simulated environment to a user of the head-mounted display apparatus, when the display apparatus is worn by the user. In such an instance, the head-mounted display apparatus is operable to act as a device (for example, such as, a virtual reality headset, a pair of virtual reality glasses, an augmented reality headset, a pair of augmented reality glasses and the like) for presenting the aforesaid simulated environment to the user.

The system comprises means for producing structured light, wherein the produced structured light is to be used to illuminate a user's eye when the head-mounted display apparatus is worn by the user, the means for producing the structured light comprising a plurality of illuminators for emitting light pulses. Throughout the present disclosure, the term “structured light” used herein refers to light that is emitted onto a surface (such as a cornea of the user's eye) in a predefined pattern, such as a matrix or a grid. Furthermore, the structured light may be produced by employing the plurality of illuminators that are arranged to correspond to the predefined pattern, such as along a matrix or a grid. In an example, the structured light is produced in a pattern such as linear, circular, triangular, rectangular, concentric circular (such as, circles having decreasing or increasing diameters with respect to each other and having a common center) and so forth. For example, when the structured light is produced in the circular pattern, the plurality of illuminators is arranged along a circle. In another example, the structured light is produced in a predefined pattern comprising text (such as one or more alphabets), symbols (such as symbol for Greek letter omega (Ω)), designs (such as logos) and so forth.

Throughout the present disclosure, the term “plurality of illuminators” used herein relates to at least one light source configured to emit light of a specific wavelength. Optionally, the plurality of illuminators is configured to emit light pulses of infrared or near-infrared wavelength. The light of infrared or near-infrared wavelength is invisible to the human eye, thereby, reducing unwanted distraction when such light is incident upon the user's eye. Alternatively, optionally, the plurality of illuminators is configured to emit light of wavelength within visible spectrum.

The means for producing structured light is arranged near the user's eye such that light pulses emitted by the plurality of illuminators are incident on the user's eye. For example, such light pulses may be incident on a cornea of the user's eye. In such an instance, the emitted light is reflected from an outer surface of the cornea of the user's eye, thereby constituting corneal reflections (namely, glints) in the user's eye.

In one embodiment, the structure of the light pulses emitted by the at least one illuminator is modified to produce the structured light of a predefined shape. For example, the plurality of illuminators of the means for producing structured light comprises the at least one illuminator. In one example, the at least one illuminator is operable to produce light pulses along a beam. It will be appreciated that a structure of the light pulses along the beam (that may be seen as reflection of the light pulses from a surface) will correspond to a circular shape. However, the light pulses emitted by the at least one illuminator may be required to have a different shape, such as a triangular shape. In such an instance, the structure of the light pulses emitted by the at least one illuminator is modified to produce the structured light of the triangular shape.

According to an embodiment, the means for producing the structured light further comprises at least one first optical element for modifying a structure of the light pulses emitted by at least one illuminator from amongst the plurality of illuminators to produce the structured light. For example, the at least one first optical element is configured to modify the structure of the light pulses by reflection and/or refraction thereof. Furthermore, the at least one first optical element may be arranged in an optical path between the at least one illuminator and the user's eye.

In one embodiment, the at least one first optical element is implemented by way of a freeform optical element or a light guide. Throughout the present disclosure, the term ‘freeform optical element’ used herein relates to optical elements that are not spherical and/or rotationally symmetric. In an example, the freeform optical element comprises a freeform lens. Such freeform lens may have different optical powers at different areas thereof. For example, a surface of a freeform lens has a triangular shape formed therein. Such triangular shape of the surface of the freeform lens is operable to focus parallel light rays emitted by the at least one illuminator to form an image corresponding to the triangular shape, such as, on the user's eye. In one example, such shape (and consequently, the image formed on the user's eye) may comprise text, one or more shapes, a design, and so forth. In one embodiment, the freeform lens is made using at least one of polymethyl methacrylate (PMMA), polycarbonate (PC), polystyrol (PS), cyclo olefin polymer (COP) and/or cyclo olefin-copolymer (COC).

Throughout the present disclosure, the term “light guide” used herein relates to an optical element that is operable to guide (such as, transmit) the light pulses emitted by the at least one illuminator towards the user's eye. In one example, the light guide is associated with one or more coupling elements for directing the light emitted by the at least one illuminator into or out of the light guide. For example, the light guide is associated with an inlet coupling element for directing light emitted by the at least one illuminator into the light guide and an outlet coupling element for directing light from the light guide towards the user's eye.

In one embodiment, the at least one illuminator is implemented by way of at least one of a projector, an light-emitting diode (LED) display, an infrared light emitter and/or a laser. In an example, the at least one illuminator that is implemented by way of the projector is arranged near the user's eye such that light pulses emitted by the projector are incident on the inlet coupling element associated with the light guide. In such an instance, the light guide is operable to guide the light pulses towards the outlet coupling element and subsequently, towards the user's eye. In another example, the at least one illuminator implemented by way of the LED display is arranged near the user's eye and is operable to produce an image and/or a video. In such an instance, the LED display is operable to produce the image and/or the video having high resolution to be emitted on the user's eye. In yet another example, the at least one illuminator is implemented by way of the infrared light emitter. In such an instance, the infrared light emitter is operable to be produce light pulses that are invisible to the user's eye.

According to an embodiment, the at least one first optical element is implemented as a part of a primary ocular lens of the head-mounted display apparatus. For example, the head-mounted display apparatus comprises one or more displays for rendering an image that is to be projected onto the user's eye. In one example, such one or more displays comprise a context image renderer for rendering a context image and a focus image renderer for rendering a focus image, wherein a projection of the rendered context image and a projection of the rendered focus image together form a projection of the image on the user's eye. Optionally, the head-mounted display apparatus further comprises at least one optical combiner for combining the projections of the rendered context image and the rendered focus image. Optionally, the at least one optical combiner is arranged for allowing the projection of the rendered context image to pass through substantially, whilst reflecting the projection of the rendered focus image substantially. Alternatively, optionally, the at least one optical combiner is arranged for allowing the projection of the rendered focus image to pass through substantially, whilst reflecting the projection of the rendered context image substantially. In such an instance, the primary ocular lens is positioned in an optical path between the at least one optical combiner and the user's eye. Furthermore, the primary ocular lens is operable to modify an optical path and/or optical characteristics of the image prior to projection thereof onto the user's eye. In one example, the primary ocular lens is operable to magnify a size (or angular dimensions) of the image. In one embodiment, the freeform optical element is a part of the primary ocular lens of the head-mounted display apparatus. For example, the freeform optical element is a freeform lens that is formed as a part of the primary ocular lens. In one example, the primary ocular lens is a progressive lens comprising the freeform lens in an area thereof having a different optical power. In such an instance, at least one illuminator is arranged near the primary ocular lens such that light pulses emitted by the at least one illuminator are substantially modified by the freeform optical element to produce structured light of a predefined shape. Alternatively and optionally, the freeform optical element is arranged adjacent to the primary ocular lens. In such an instance, at least one illuminator is arranged such that the freeform optical lens lies on an optical path between the at least one illuminator and the user's eye.

According to one embodiment, the light guide is arranged on an optical path between the at least one optical combiner and the user's eye. For example, the light guide is arranged such that light pulses emitted by the at least one illuminator is guided by the light guide towards the user's eye. In such an instance, the light pulses emitted by the at least one illuminator is used to illuminate the user's eye.

In an embodiment, the light guide is a part of the primary ocular lens of the head-mounted display apparatus. For example, the light guide is operable to transmit light pulses emitted by the at least one illuminator towards the primary ocular lens to produce the structured light (such as an image) thereon. In such an instance, a projection of the structured light on the primary ocular lens is used to illuminate the user's eye. In one example, the primary ocular lens further comprises at least one coupling element (such as an inlet and/or an outlet coupling element) associated with the light guide.

The system comprises at least one camera for capturing an image of reflections of the structured light from the user's eye, wherein the image is representative of a form of the reflections and a position of the reflections on an image plane of the at least one camera. It will be appreciated that light pulses associated with the structured light that is used to illuminate the user's eye will be reflected therefrom, for example, from the cornea of the user's eye. In such an instance, the camera is operable to capture the image of the reflections of the structured light on the cornea of the user's eye. In one example, the image plane of the at least one camera corresponds to a lens associated with the camera.

In one embodiment, the form of the reflections and the position of the reflections of the structured light from the user's eye are used to determine a shape of the user's eye. It will be appreciated that human eye has an irregular shape, such as a shape that substantially deviates from a perfect sphere. Therefore, the structured light that is used to illuminate the user's eye will be reflected by different amounts (such as, at different angles) by different regions of the user's eye. Furthermore, such reflections of the structured light is captured by the at least one camera in the image. In one example, the structured light is produced by six illuminators arranged along a circular pattern. In such an instance, a first illuminator of the six illuminators emits light towards a top-right side region of the user's eye, a second illuminator emits light towards a middle-right side region of the user's eye, and a third illuminator emits light towards a bottom-right side region of the user's eye. Furthermore, a fourth illuminator of the six illuminators emits light towards a bottom-left side region of the user's eye, a fifth illuminator emits light towards a middle-left side region of the user's eye, and a sixth illuminator emits light towards a top-left side region of the user's eye. It will be appreciated that the reflections of light emitted by the second and fifth illuminators that are operable to illuminate middle regions of user's eye will have an angle of reflection that is substantially similar to an angle of incidence of the light. However, reflections of light associated with other regions of the user's eye (such as, left, right, top and/or bottom portions) will be reflected at substantially greater angles. In such an instance, the captured image of reflections of the structured light near the middle region of the user's eye will be represented by the form and the position that is substantially similar to the predefined shape and the position of the structured light that is emitted by the plurality of illuminators. However, captured image of reflections of the structured light that is away from the middle portion of the user's eye will be represented by form and position that substantially deviates from the predefined shape and position of the structured light emitted by the plurality of illuminators. Consequently, such representation of the form and position of the reflections of the structured light by different portions of the user's eye can be used to determine the shape thereof.

In an embodiment, the gaze-tracking system further comprises at least one second optical element having an infrared reflective coating, wherein the structured light is infrared light, and the at least one second optical element is arranged to reflect the structured light towards the user's eye and to reflect the reflections of the structured light from the user's eye towards the at least one camera, the at least one second optical element being substantially transparent to visible light. For example, the at least one second optical element is implemented by way of a semi-transparent mirror having the infrared reflective coating thereon, wherein the at least one second optical element is arranged in the optical path between the at least one optical combiner and the user's eye. In such an instance, at least one illuminator of the plurality of illuminators is configured to emit infrared light. Furthermore, the at least one illuminator is arranged such that the structured light comprising infrared light emitted therefrom is reflected by the at least one second optical element. Moreover, such structured light reflected by the at least one second optical element is used to illuminate the user's eye. However, the at least one second optical element being substantially transparent to visible light, enables combined projections of the context and focus images (rendered by the context image renderer and the focus image renderer respectively) to substantially pass through towards the user's eye. Additionally, the at least one camera is arranged to capture reflections of the structured light from the user's eye. In one example, the structured light is near-infrared light. It will be appreciated that in such an instance, the at least one second optical element has a near-infrared reflective coating and furthermore, the at least one camera is configured to capture images associated with lights having near-infrared wavelength.

In one embodiment, at least one illuminator of the plurality of illuminators is configured to emit visible light and at least one illuminator of the plurality of illuminators is configured to emit infrared light. In one example, the plurality of illuminators comprise six illuminators arranged along a circular pattern, such that a first, third and fifth illuminators are configured to emit visible light and a second, fourth and sixth illuminators are configured to emit infrared light. In such an instance, the at least one first optical element implemented by way of a light guide and the at least one second optical element are arranged in the optical path towards the user's eye. Furthermore, visible light emitted by the first, third and fifth illuminators is transmitted by the light guide and the infrared light emitted by the second, fourth and sixth illuminators is reflected by the at least one second element, to illuminate the user's eye with structured light in a predefined pattern.

Optionally, the at least one second optical element is implemented as a part of the at least one optical combiner. Optionally, in this regard, the at least one second optical element and the at least one optical combiner are implemented by way of a single structure. More optionally, in the single structure, the at least one second optical element faces the primary ocular lens.

According to an embodiment, the plurality of illuminators comprise at least a first set of illuminators and a second set of illuminators, wherein a wavelength of light emitted by the first set of illuminators is different from a wavelength of light emitted by the second set of illuminators. For example, the plurality of illuminators is configured to emit light of infrared wavelength. Furthermore, the plurality of illuminators comprise six illuminators arranged along a circular pattern, wherein a first, second and third illuminators are operable to illuminate a top-right, middle-right and bottom-right portions of the user's eye respectively, and a fourth, fifth and sixth illuminators are operable to illuminate a bottom-left, middle-left and top-left portions of the user's eye respectively. In such an instance, the first set of illuminators comprising the first, third, fourth and sixth illuminators are configured to emit light of wavelength in a range of 815-822 nanometers. Moreover, the second set of illuminators comprising the second and fifth illuminators are configured to emit light of wavelength in a range of 823-830 nanometers. In one embodiment, the camera comprises an infrared multichannel sensor. In such an instance, the camera is operable to detect the reflections of infrared light of different wavelengths emitted by the first set of illuminators and the second set of illuminators.

The system comprises a processor coupled in communication with the means for producing the structured light and the at least one camera, wherein the processor is configured to control the means for producing the structured light to illuminate the user's eye with the structured light and to control the at least one camera to capture the image of the reflections of the structured light, and to process the captured image to detect a gaze direction of the user. For example, the processor is configured to control the means for producing the structured light to illuminate the user's eye when the gaze direction of the user is required to be detected. In one example, the means for producing the structured light comprises six illuminators arranged along a circular pattern, wherein a first, second and third illuminators of the six illuminators are operable to illuminate a top-right, middle-right and bottom-right portions of the user's eye respectively, and a fourth, fifth and sixth illuminators are operable to illuminate a bottom-left, middle-left and top-left portions of the user's eye respectively. In such an instance, the processor is configured to control the means for producing the structured light such that the second illuminator produces light pulses having a triangular shape and the fifth illuminator produces light pulses having a rectangular shape. Furthermore, the processor is configured to control the first, third, fourth and sixth illuminators to produce light pulses having a circular shape.

Subsequently, the processor is configured to control the at least one camera to capture the image of the reflections of the structured light. Furthermore, the at least one camera is configured to transmit the captured image of the reflections of the structured light to the processor. In such an instance, the processor is operable to process the captured image to determine the form and the position of the reflections of the structured light in the captured image. In one example, the processor is operable to determine a position of pupil of the user's eye with respect to the form and the position of the reflections of the structured light in the captured image to detect the gaze direction of the user. It will be appreciated that such use of light pulses having the triangular shape and the rectangular shape along with light pulses having the circular shape (such as light pulses that are not modified by the at least one first optical element) enables to determine the form and position of reflections of the structured light in the captured image. For example, when eyelids of the user are partially closed such that reflections of light pulses emitted by the first and the sixth illuminators are not visible in the captured image, the reflections associated with other illuminators can still be determined to high certainty based on the form and position of reflections of light pulses emitted by the second and fifth illuminators. Alternatively, when more than six reflections are determined in the captured image (such as, reflections associated with light emitted by ambient light sources), the form and positions of the reflections of the structured light can be determined based on the form and positions of reflections of light pulses by the second and fifth illuminators. Therefore, it will be appreciated that such determination of gaze direction of the user using the structured light is associated with reduced errors and high accuracy as compared to existing gaze detection techniques.

In one embodiment, the processor is operable to compare the form and the position of the reflections of the structured in the captured image with the predefined shape and the position of the structured light emitted by the means for producing the structured light. In such an instance, the processor is configured to store the predefined shape and position of the structured light emitted by the means for producing the structured light. Furthermore, the processor is configured to correct the detected position of pupil of the user's eye based on a change in the form of the reflections as compared to the predefined shape of the structured light and/or a change in position as compared to the stored position of the structured light.

In an embodiment, the plurality of illuminators are implemented by way of a plurality of pixels of a display of the head-mounted display apparatus, wherein the display is to be employed to flash a form to produce the structured light, the structured light having a shape that is substantially similar to a shape of the flashed form. For example, the display of the head-mounted display comprises a focus image renderer for rendering a focus image that is employed to present a projection of an image (such as an image of a virtual scene of a simulated environment) on the user's eyes. In such an instance, such display is operable to flash the form to produce the structured light, such as the form comprising an image, a shape, a symbol and so forth.

According to an embodiment, the processor is configured to control the plurality of pixels of the display to operate an illumination functionality and an image display functionality of the display in a non-overlapping manner, wherein the image display functionality is to be operated for displaying a focus image to the user. For example, the display comprising the plurality of pixels is associated with a high frame rate of display. Furthermore, the display is associated with a focus image renderer that is operated for displaying the focus image to the user. In such an instance, the illumination functionality of the plurality of pixels is controlled by the processor such that the form is flashed on the display in between displaying (or rendering) the focus image. For example, the processor is configured to operate the image display functionality of the display (such as the focus image renderer) to render a focus image for 1 second. In such an instance, the processor is configured to operate the illumination functionality of the display to produce the structured light at time point corresponding to 50 milliseconds during rendering of the focus image (such as, in between rendering of frames associated with the focus image).

In one embodiment, the processor is configured to divide the plurality of illuminators into a plurality of illuminator groups, and to control individual illuminator groups of the plurality of illuminator groups to emit the light pulses in a predefined manner, based upon a time-division multiplexing rule. For example, the plurality of illuminators comprising six illuminators arranged along a circular pattern, wherein a first, second and third illuminators are operable to illuminate a top-right, middle-right and bottom-right portions of the user's eye respectively, and a fourth, fifth and sixth illuminators are operable to illuminate a bottom-left, middle-left and top-left portions of the user's eye respectively. In such an instance, the processor is configured to divide the six illuminators into a first illuminator group comprising the first, third and fifth illuminators and into a second illuminator group comprising the second, fourth and sixth illuminators. Furthermore, the processor is configured to control the first and the second illuminator groups to emit light pulses in an alternate manner (such as, light pulses are emitted by the first illuminator group and subsequently, light pulses are emitted by the second illuminator group).

Optionally, the head-mounted display apparatus further comprises at least one actuator for moving the at least one optical combiner, wherein the processor is configured to control the at least one actuator to adjust at least one of: (i) a location of the projection of the rendered context image, (ii) a location of the projection of the rendered focus image, on the primary ocular lens. In such an instance, the processor may control the at least one actuator by generating an actuation signal (for example, such as an electric current, hydraulic pressure, mechanical force, and so forth). Furthermore, optionally, such movement includes at least one of: displacement (namely, horizontally, and/or vertically), rotation, and/or tilting of the at least one optical combiner. For example, the at least one actuator is coupled to the processor that is configured to provide the actuation signal to the at least one actuator to rotate the at least one optical combiner (such as, rotation of the at least one optical combiner about an axis passing through the center thereof). In such an instance, for example, the at least one optical combiner is rotated to adjust a location of the projection of the rendered focus image on the primary ocular lens.

Optionally, the at least one second optical element is coupled to the at least one optical combiner in a manner that movement of the at least one optical combiner enables movement of the at least one second optical element.

Optionally, the at least one optical combiner is static. Beneficially, such static at least one optical combiner allows for reduction in optical distortion of the focus and context images.

In an embodiment, the processor is configured to calibrate the gaze-tracking system by determining an initial position of the head-mounted display apparatus with respect to the user's eye, whilst recording a form and a position of the reflections as represented by an image captured substantially simultaneously by the at least one camera. For example, when the head-mounted display apparatus is worn by the user, a calibration sequence is started. In such an instance, upon adjustment of the head-mounted display apparatus by the user according to requirements thereof (such as, in a comfortable position), the user's eye is illuminated by the means for producing the structured light. Subsequently, the image is captured by the at least one camera to determine the initial position of the head-mounted display apparatus with respect to the user's eye. Such captured image will be representative of the form and the position of the reflections of light emitted by the means for producing the structured light corresponding to the initial position of the head-mounted display apparatus with respect to the user's eye.

Furthermore, the processor is configured to calibrate the gaze-tracking system by storing information indicative of the initial position with respect to the recorded form and position of the reflections. For example, the form and the position of the reflections as represented by the captured image that is stored, such as, in a memory associated with the processor. In another example, the processor is operable to store numerical values associated with the form and the position of the reflections, such as numerical values of coordinates associated with the reflections as represented by the captured image.

Moreover, the processor is configured to calibrate the gaze-tracking system by determining a change in the position of the head-mounted display apparatus with respect to the user's eye, based upon a change in the form and/or the position of the reflections as represented by a new image captured at a later time with respect to the recorded form and position of the reflections. For example, in operation, the head-mounted display may shift from the initial position thereof on the user's head due to movement of the user's head. In such an instance, the processor is operable to control the at least one camera to capture the new image representative of the form and/or the position of the reflections due to such movement of the user's head. In one example, the processor is configured to control the at least one camera to capture new images at regular intervals during operation, such as, at every five seconds during operation of the head-mounted display apparatus. Furthermore, the processor is operable to compare the form and positions of reflections in the new image with the initial position of the form and position of the reflections and subsequently, calibrate the gaze-tracking system according to such change.

According to an embodiment, the processor is configured to selectively employ at least one illuminator from amongst the plurality of illuminators to illuminate the user's eye, and to selectively employ at least one other illuminator from amongst the plurality of illuminators, in addition to the at least one illuminator, when the at least one illuminator is not sufficient for detecting the gaze direction of the user. For example, the plurality of illuminators comprise six illuminators arranged along a circular pattern, wherein a first, second and third illuminators are operable to illuminate a top-right, middle-right and bottom-right portions of the user's eye respectively, and a fourth, fifth and sixth illuminators are operable to illuminate a bottom-left, middle-left and top-left portions of the user's eye respectively. Furthermore, structure of the light pulses emitted by the second illuminator is modified to produce a hollow triangular shape. Moreover, structure of the light pulses emitted by the fifth illuminator is modified to produce a hollow circular shape. In such an instance, the processor is operable to determine a certainty associated with the detected gaze direction of the user. For example, the certainty associated with the detected gaze direction of the user comprises information associated with presence of ambient light sources near the user, shape of user's eye, and so forth. In one example, the gaze direction of the user is determined to be associated with high certainty. In such an instance, the processor is operable to selectively employ the second and fifth illuminators to illuminate the user's eye with light pulses of the hollow triangular shape and hollow circular shape respectively that may be sufficient to determine the gaze direction of the user. In another example, the gaze direction of the user is determined to be associated with low certainty. In such an instance, the processor is operable to employ the first, third, fourth and sixth illuminators as well as the second and fifth illuminators for detecting the gaze direction of the user.

The present disclosure also relates to the method as described above. Various embodiments and variants disclosed above apply mutatis mutandis to the method.

### DETAILED DESCRIPTION OF THE DRAWINGS

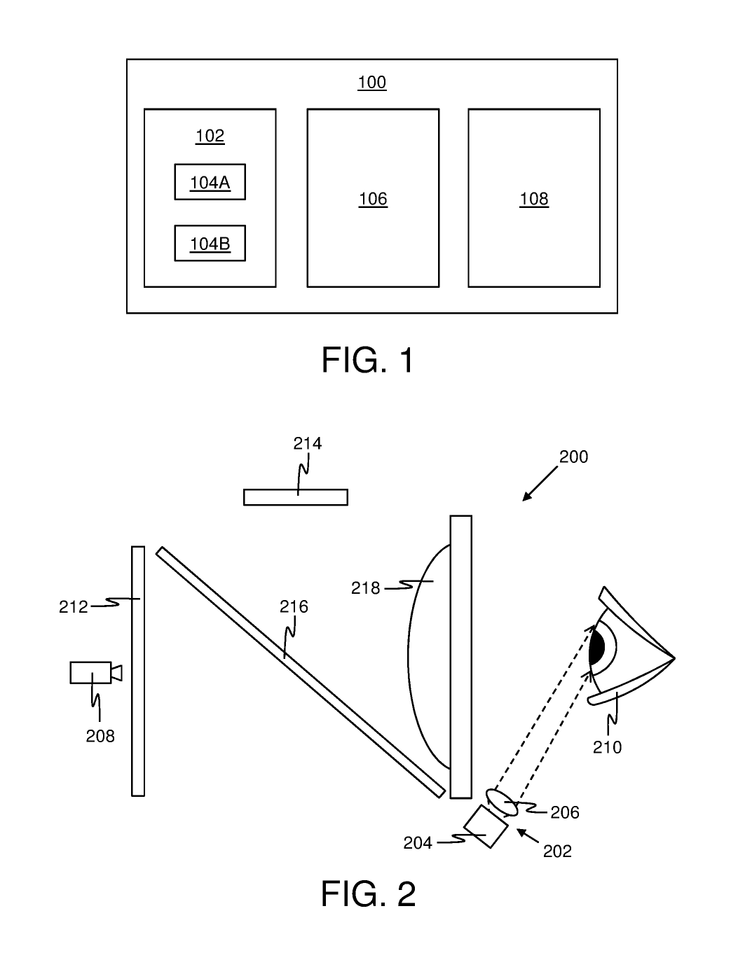

Referring to FIG. 1, illustrated is a block diagram of a gaze-tracking system 100 for use in a head-mounted display apparatus (not shown), in accordance with an embodiment of the present disclosure. The gaze-tracking system 100 comprises means for producing structured light 102, wherein the produced structured light is to be used to illuminate a user's eye when the head-mounted display apparatus is worn by the user, the means for producing the structured light 102 comprising a plurality of illuminators 104A-B for emitting light pulses. Furthermore, the gaze-tracking system 100 comprises at least one camera, depicted as a camera 106, for capturing an image of reflections of the structured light from the user's eye, wherein the image is representative of a form of the reflections and a position of the reflections on an image plane of the at least one camera 106. Moreover, the gaze-tracking system 100 comprises a processor 108 coupled in communication with the means for producing the structured light 102 and the at least one camera 106, wherein the processor 108 is configured to control the means for producing the structured light 102 to illuminate the user's eye with the structured light and to control the at least one camera 106 to capture the image of the reflections of the structured light, and to process the captured image to detect a gaze direction of the user.

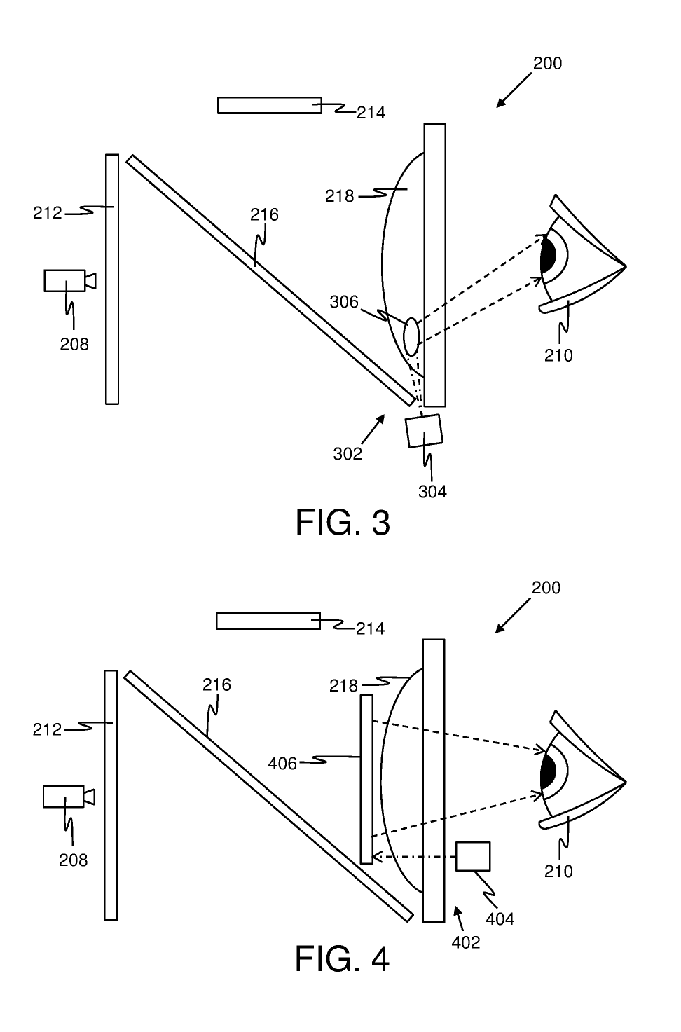

Referring to FIGS. 2, 3, 4, and 5 illustrated are exemplary implementations of the gaze-tracking system 100 (as shown in FIG. 1) in use within a head-mounted display apparatus (not shown), in accordance with various embodiments of the present disclosure. It may be understood by a person skilled in the art that the FIGS. 2, 3, 4 and 5 include simplified arrangements for implementation of the gaze-tracking system 100 for sake of clarity, which should not unduly limit the scope of the claims herein. The person skilled in the art will recognize many variations, alternatives, and modifications of embodiments of the present disclosure.

Referring to FIG. 2, illustrated is an exemplary implementation of a gaze-tracking system 200 (such as the gaze-tracking system 100 of FIG. 1) for use in a head-mounted display apparatus, in accordance with an embodiment of the present disclosure. The gaze-tracking system 200 comprises means for producing structured light 202. As shown, the means producing structured light 202 comprises an at least one illuminator 204 for emitting light pulses. The means for producing the structured light 202 further comprises at least one first optical element 206 that is implemented by way of a freeform optical element. The at least one first optical element 206 is arranged to modify a structure of the light pulses emitted by at least one illuminator 204 to produce the structured light. Furthermore, the gaze-tracking system 200 comprises at least one camera 208 for capturing an image of reflections of the structured light from user's eye 210 and a processor (not shown) coupled in communication with the means for producing the structured light 202 and the at least one camera 208. Additionally, optionally, the head-mounted display apparatus comprises a context image renderer implemented by way of a context display 212 for rendering a context image and a focus image renderer implemented by way of a focus display 214 for rendering a focus image. Moreover, optionally, the head-mounted display apparatus comprises at least one optical combiner, depicted as an optical combiner 216 for combining projection of the rendered context image with the projection of the rendered focus image, and a primary ocular lens 218 positioned in an optical path between the at least one optical combiner 216 and the user's eye 210. Optionally, at least one optical combiner 216 is coupled to at least one actuator (not shown) for moving the at least one optical combiner 216. Optionally, such movement includes at least one of: displacement (namely, horizontally, and/or vertically), rotation, and/or tilting of the at least one optical combiner 216. Optionally, the at least one actuator is further coupled to the processor.

Referring to FIG. 3, illustrated is an exemplary implementation of the gaze-tracking system 200 (of FIG. 2) for use in a head-mounted display apparatus, in accordance with another embodiment of the present disclosure. As shown, means for producing structured light 302 comprises an at least one illuminator 304 for emitting light pulses. The means for producing the structured light 302 further comprises at least one first optical element 306 implemented by way of a freeform optical element. As shown, the at least one first optical element 306 is implemented as a part of the primary ocular lens 218 of the head-mounted display apparatus.

Referring to FIG. 4, illustrated is an exemplary implementation of the gaze-tracking system 200 (of FIG. 2) for use in a head-mounted display apparatus, in accordance with yet another embodiment of the present disclosure. As shown, means for producing structured light 402 comprises an at least one illuminator 404 for emitting light pulses. For example, the at least one illuminator 404 is implemented by way of a light-emitting diode (LED) display. The means for producing structured light 402 further comprises at least one first optical element 406 implemented by way of a light guide. As shown, the at least one first optical element 406 is implemented as a part of the primary ocular lens 218 of the head-mounted display apparatus.

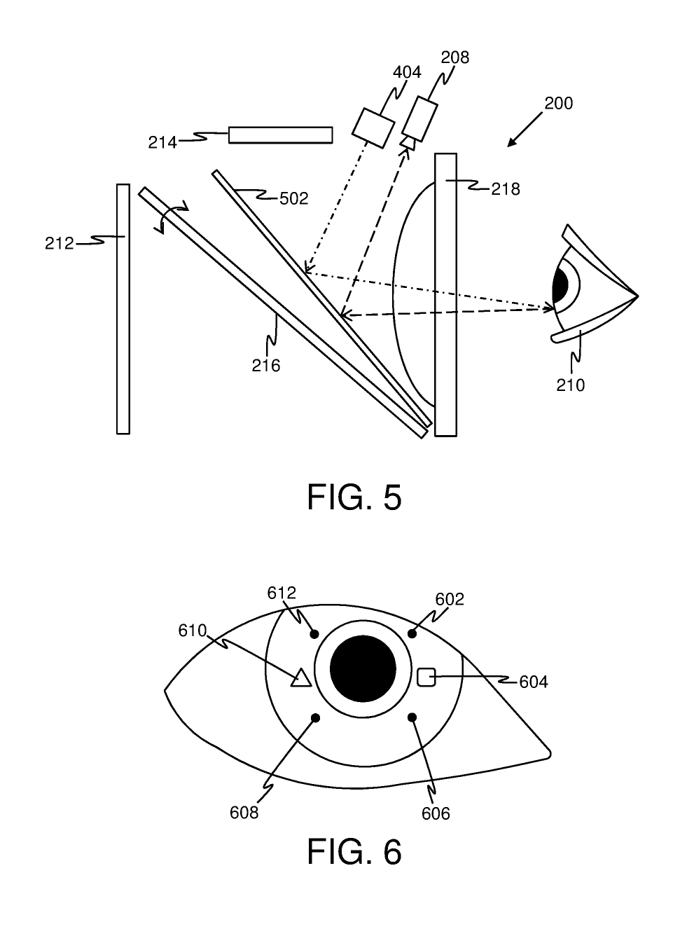

Referring to FIG. 5, illustrated is an exemplary implementation of the gaze-tracking system 200 (of FIG. 2) for use in a head-mounted display apparatus, in accordance with yet another embodiment of the present disclosure. As shown, the head-mounted display apparatus comprises the at least one optical combiner 216. Moreover, the gaze-tracking system 200 comprises the at least one illuminator 404, and a second optical element 502 having an infrared reflective coating. In such an instance, the structured light is infrared light. As shown, the second optical element 502 is arranged to reflect the structured light towards the user's eye 210 and to reflect the reflections of the structured light from the user's eye 210 towards the at least one camera 208. Moreover, the second optical element 502 is substantially transparent to visible light to enable projections of the context and focus images from the at least one optical combiner 216 to substantially pass through towards the user's eye 210.Referring to FIG. 6, illustrated is an exemplary image of a user's eye (such as the user's eye 210 of FIG. 2) captured by at least one camera (such as the at least one camera 208 of FIG. 2), in accordance with an embodiment of the present disclosure. As shown, the captured image comprises reflections 602-612 of structured light from the user's eye. Furthermore, the structured light is produced by means for producing the structured light comprising six illuminators for emitting light pulses that are arranged along a circular pattern. As shown, reflection 604 is produced by modifying structure of light pulses emitted by at least one illuminator from amongst the six illuminators, to produce the structured light of a rounded-square shape. Furthermore, reflection 610 is produced by modifying structure of the light pulses emitted by at least one illuminator from amongst the six illuminators, to produce the structured light of a triangular shape. However, reflections 602, 606, 608 and 612 are produced without modification of structure of the light pulses emitted the illuminators.

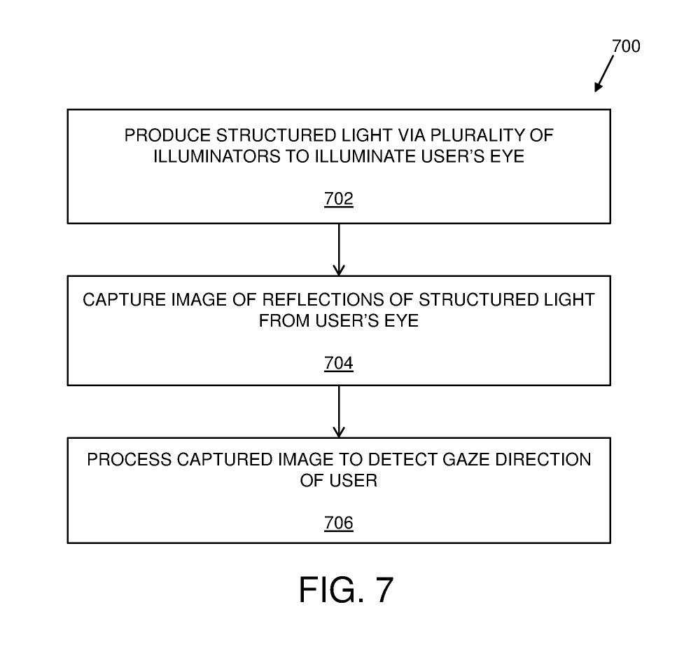

Referring to FIG. 7, illustrated are steps of a method 700 of tracking a user's gaze, via a gaze-tracking system of a head-mounted display apparatus, in accordance with an embodiment of the present disclosure. At step 702, structured light is produced via a plurality of illuminators, to illuminate a user's eye when the head-mounted display apparatus is worn by the user. At step 704, an image of reflections of the structured light from the user's eye is captured, the image being representative of a form of the reflections and a position of the reflections on an image plane of the at least one camera. At step 706, the captured image is processed to detect a gaze direction of the user.

The steps 702 to 706 are only illustrative and other alternatives can also be provided where one or more steps are added, one or more steps are removed, or one or more steps are provided in a different sequence without departing from the scope of the claims herein. In an example, the step of producing the structured light comprises arranging at least one first optical element of the gaze-tracking system to modify a structure of light pulses emitted by at least one illuminator from amongst the plurality of illuminators. In one example, the gaze-tracking system further comprises at least one second optical element having an infrared reflective coating, the structured light being infrared light, and wherein the method further comprises arranging the at least one second optical element to reflect the structured light towards the user's eye and to reflect the reflections of the structured light from the user's eye towards the at least one camera, the at least one second optical element being substantially transparent to visible light. In another example, the plurality of illuminators are implemented by way of a plurality of pixels of a display of the head-mounted display apparatus, wherein the step of producing the structured light comprises employing the display to flash a form, such that the structured light has a shape that is substantially similar to a shape of the flashed form. In one example, the method further comprises controlling the plurality of pixels of the display to operate an illumination functionality and an image display functionality of the display in a non-overlapping manner, wherein the image display functionality is operated for displaying a focus image to the user. In another example, the step of producing the structured light comprises dividing the plurality of illuminators into a plurality of illuminator groups; and controlling individual illuminator groups of the plurality of illuminator groups to emit the light pulses in a predefined manner, based upon a time-division multiplexing rule. In an example, the method further comprises selectively employing at least one illuminator from amongst the plurality of illuminators to illuminate the user's eye; and selectively employing at least one other illuminator from amongst the plurality of illuminators, in addition to the at least one illuminator, when the at least one illuminator is not sufficient for detecting the gaze direction of the user. In another example, the method further comprises calibrating the gaze-tracking system by determining an initial position of the head-mounted display apparatus with respect to the user's eye, whilst recording a form and a position of the reflections as represented by an image captured substantially simultaneously by the at least one camera; storing information indicative of the initial position with respect to the recorded form and position of the reflections; and determining a change in the position of the head-mounted display apparatus with respect to the user's eye, based upon a change in the form and/or the position of the reflections as represented by a new image captured at a later time with respect to the recorded form and position of the reflections.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A gaze-tracking system for use in a head-mounted display apparatus, the gaze-tracking system comprising:
means for producing structured light, wherein the produced structured light is to be used to illuminate a user's eye when the head-mounted display apparatus is worn by the user, the means for producing the structured light comprising a plurality of illuminators for emitting light pulses;
at least one camera for capturing an image of reflections of the structured light from the user's eye, wherein the image is representative of a form of the reflections and a position of the reflections on an image plane of the at least one camera; and
a processor coupled in communication with the means for producing the structured light and the at least one camera, wherein the processor is configured to control the means for producing the structured light to illuminate the user's eye with the structured light and to control the at least one camera to capture the image of the reflections of the structured light, and to process the captured image to detect a gaze direction of the user.

2. The gaze-tracking system of claim 1, wherein the means for producing the structured light further comprises at least one first optical element for modifying a structure of the light pulses emitted by at least one illuminator from amongst the plurality of illuminators to produce the structured light.

3. The gaze-tracking system of claim 2, wherein the structure of the light pulses emitted by the at least one illuminator is modified to produce the structured light of a predefined shape.

4. The gaze-tracking system of claim 2, wherein the at least one first optical element is implemented by way of a freeform optical element or a light guide.

5. The gaze-tracking system of claim 2, wherein the at least one first optical element is implemented as a part of a primary ocular lens of the head-mounted display apparatus.

6. The gaze-tracking system of claim 1, further comprising at least one second optical element having an infrared reflective coating, wherein the structured light is infrared light, and the at least one second optical element is arranged to reflect the structured light towards the user's eye and to reflect the reflections of the structured light from the user's eye towards the at least one camera, the at least one second optical element being substantially transparent to visible light.

7. The gaze-tracking system of claim 1, wherein the plurality of illuminators are implemented by way of a plurality of pixels of a display of the head-mounted display apparatus, wherein the display is to be employed to flash a form to produce the structured light, the structured light having a shape that is substantially similar to a shape of the flashed form.

8. The gaze-tracking system of claim 7, wherein the processor is configured to control the plurality of pixels of the display to operate an illumination functionality and an image display functionality of the display in a non-overlapping manner, wherein the image display functionality is to be operated for displaying a focus image to the user.

9. The gaze-tracking system of claim 1, wherein the plurality of illuminators comprise at least a first set of illuminators and a second set of illuminators, wherein a wavelength of light emitted by the first set of illuminators is different from a wavelength of light emitted by the second set of illuminators.

10. The gaze-tracking system of claim 1, wherein the processor is configured to divide the plurality of illuminators into a plurality of illuminator groups, and to control individual illuminator groups of the plurality of illuminator groups to emit the light pulses in a predefined manner, based upon a time-division multiplexing rule.

11. The gaze-tracking system of claim 1, wherein the processor is configured to selectively employ at least one illuminator from amongst the plurality of illuminators to illuminate the user's eye, and to selectively employ at least one other illuminator from amongst the plurality of illuminators, in addition to the at least one illuminator, when the at least one illuminator is not sufficient for detecting the gaze direction of the user.

12. The gaze-tracking system of claim 1, wherein the processor is configured to calibrate the gaze-tracking system by:
determining an initial position of the head-mounted display apparatus with respect to the user's eye, whilst recording a form and a position of the reflections as represented by an image captured substantially simultaneously by the at least one camera;
(ii) storing information indicative of the initial position with respect to the recorded form and position of the reflections; and
(iii) determining a change in the position of the head-mounted display apparatus with respect to the user's eye, based upon a change in the form and/or the position of the reflections as represented by a new image captured at a later time with respect to the recorded form and position of the reflections.

13. A method of tracking a user's gaze, via a gaze-tracking system of a head-mounted display apparatus, the method comprising:
producing structured light, via a plurality of illuminators, to illuminate a user's eye when the head-mounted display apparatus is worn by the user;
capturing an image of reflections of the structured light from the user's eye, the image being representative of a form of the reflections and a position of the reflections on an image plane of the at least one camera; and
processing the captured image to detect a gaze direction of the user.

14. The method of claim 13, wherein the step of producing the structured light comprises arranging at least one first optical element of the gaze-tracking system to modify a structure of light pulses emitted by at least one illuminator from amongst the plurality of illuminators.

15. The method of claim 13, wherein the gaze-tracking system further comprises at least one second optical element having an infrared reflective coating, the structured light being infrared light, and wherein the method further comprises arranging the at least one second optical element to reflect the structured light towards the user's eye and to reflect the reflections of the structured light from the user's eye towards the at least one camera, the at least one second optical element being substantially transparent to visible light.

16. The method of claim 13, wherein the plurality of illuminators are implemented by way of a plurality of pixels of a display of the head-mounted display apparatus, wherein the step of producing the structured light comprises employing the display to flash a form, such that the structured light has a shape that is substantially similar to a shape of the flashed form.

17. The method of claim 16, further comprising controlling the plurality of pixels of the display to operate an illumination functionality and an image display functionality of the display in a non-overlapping manner, wherein the image display functionality is operated for displaying a focus image to the user.

18. The method of claim 13, wherein the step of producing the structured light comprises dividing the plurality of illuminators into a plurality of illuminator groups; and controlling individual illuminator groups of the plurality of illuminator groups to emit the light pulses in a predefined manner, based upon a time-division multiplexing rule.

19. The method of claim 13, further comprising selectively employing at least one illuminator from amongst the plurality of illuminators to illuminate the user's eye; and selectively employing at least one other illuminator from amongst the plurality of illuminators, in addition to the at least one illuminator, when the at least one illuminator is not sufficient for detecting the gaze direction of the user.

20. The method of claim 13, further comprising calibrating the gaze-tracking system by:
determining an initial position of the head-mounted display apparatus with respect to the user's eye, whilst recording a form and a position of the reflections as represented by an image captured substantially simultaneously by the at least one camera;
(ii) storing information indicative of the initial position with respect to the recorded form and position of the reflections; and
(iii) determining a change in the position of the head-mounted display apparatus with respect to the user's eye, based upon a change in the form and/or the position of the reflections as represented by a new image captured at a later time with respect to the recorded form and position of the reflections.
